(19) United States
(12) Patent Application Publication
(10) Pub. No.: US 2021/0342388 A1
(43) Pub. Date: Nov. 4, 2021

(54) IDENTIFYING EQUIPMENT ASSEMBLY INFORMATION BASED ON IMAGE DATA

(71) Applicant: Rockwell Automation Technologies, Inc., Mayfield Heights, OH (US)

(72) Inventors: Thong T. Nguyen, New Berlin, WI (US); Paul D. Schmirler, Glendale, WI (US); Hannah M. Schermerhorn, Milwaukee, WI (US); Kyle Crum, Bayside, WI (US); Abhishek Mehrotra, New Berlin, WI (US); Kristopher J. Holley, Mequon, WI (US)

(21) Appl. No.: 16/863,768

(22) Filed: Apr. 30, 2020

(51) Int. Cl. G06F 16/538; G06F 16/55

(52) U.S. Cl. CPC G06F 16/538; G06F 16/55

(57) ABSTRACT

A method executable by at least one processor includes receiving image data representative of an industrial equipment assembly, identifying properties associated with the industrial equipment assembly based on the image data, identifying a set of industrial equipment assemblies associated with the industrial equipment assembly based on the properties associated with the industrial equipment assembly and data stored in a database, and categorizing the set of industrial equipment assemblies based on the data associated with the industrial equipment assemblies. The method also includes generating an inquiry based on the categorization of the set of industrial equipment assemblies, presenting the inquiry via an electronic display, receiving information responsive to the inquiry and associated with the industrial equipment assembly, identifying a subset of industrial equipment assemblies based on the information, and presenting a visualization associated with the subset of industrial equipment assemblies via the electronic display.

### BACKGROUND

The present disclosure relates generally to identifying information based on image data. More particularly, embodiments of the present disclosure are related to systems and methods for identifying certain features related to industrial automation components or assemblies in image data to present visualizations to a user.

This section is intended to introduce the reader to various aspects of art that may be related to various aspects of the present techniques and are described and/or claimed below. This discussion is believed to be helpful in providing the reader with background information to facilitate a better understanding of the various aspects of the present disclosure. Accordingly, it should be noted that these statements are to be read in this light, and not as admissions of prior art.

A user may be responsible for performing tasks on industrial components of industrial systems. For example, the user may be a technician that may perform maintenance on a variety of industrial components or an industrial assembly (e.g., collection of components). In some circumstances, the user may not be familiar with one of the industrial components or a particular assembly and/or may request to acquire additional information regarding the industrial component or assembly. Accordingly, it is desirable to develop ways to facilitate automatically identifying and presenting information to the user based on an image data associated with the industrial component or assembly.

### BRIEF DESCRIPTION

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method executable by at least one processor includes receiving image data representative of an industrial equipment assembly, identifying properties associated with the industrial equipment assembly based on the image data, identifying a set of industrial equipment assemblies associated with the industrial equipment assembly based on the properties associated with the industrial equipment assembly and data associated with industrial equipment assemblies stored in a database, and categorizing the set of industrial equipment assemblies based on the data associated with the industrial equipment assemblies. The method also includes generating an inquiry based on the categorization of the set of industrial equipment assemblies, presenting the inquiry via an electronic display, receiving information responsive to the inquiry and associated with the industrial equipment assembly, identifying a subset of industrial equipment assemblies from the set of industrial equipment assemblies based on the information, and presenting a visualization associated with the subset of industrial equipment assemblies via the electronic display.

In an embodiment, a non-transitory computer-readable medium includes computer-executable instructions that, when executed by processing circuitry, may cause the processing circuitry to perform operations that include receiving first image data representative of a motor control center (MCC) in a closed configuration, receiving second image data representative of the MCC in an open configuration, identifying first properties associated with the MCC in the closed configuration based on the first image data, and identifying second properties associated with the MCC in the open configuration based on second image data. The instructions, when executed by the processing circuitry, may also cause the processing circuitry to perform operations that include identifying a set of components of the MCC based on the first properties, the second properties, or both, identifying a set of MCCs that is associated with the MCC based on the first properties and based on data associated with MCCs stored in database, the second properties, the set of components, or any combination thereof, and presenting a visualization representative of the set of MCCs via an electronic display.

In an embodiment, a system includes a database that stores data associated with industrial components and includes a computing system that performs operations that include receiving image data representative of a component, determining first properties of the component based on the image data, identifying a set of industrial components from the industrial components based on the first properties of the component and based on the data associated with the industrial components stored in the database, and categorizing the set of industrial components based on second properties associated with the set of industrial components. The computing system also performs operations that include generating a set of inquiries based on the categorization of the set of industrial components, presenting an inquiry of the set of inquiries via an electronic display, receiving additional information based on the inquiry, identifying a subset of industrial components from the set of industrial components based on the additional information, and presenting a visualization representative of at least one industrial component of the subset of industrial components via the electronic display.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an embodiment of an image processing system that may be used for identifying information based on image data, in accordance with an embodiment of the present disclosure;

FIG. 2 is a flowchart of an embodiment of a method or process for outputting visualizations regarding components based on image data and additional information, in accordance with an embodiment of the present disclosure;

FIG. 3 is a flowchart of an embodiment of a method or process for identifying relevant industrial equipment assemblies based on image data, in accordance with an embodiment of the present disclosure; and

FIG. 4 is a flowchart of an embodiment of a method or process for outputting visualizations regarding relevant industrial equipment assemblies based on received information, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

An industrial system (e.g., an industrial plant, a factory) may include various industrial components. As used herein, an industrial component refers to any suitable device (e.g., mechanical machinery, electromechanical machinery) that may perform a function to facilitate the operation of the industrial system. For instance, the industrial component may include a controller, a drive, a motor, a sensor, a conveyor, an input/output (I/O) module, a motor control center, human machine interface (HMI), a user interface, a contactor, a starter, a relay, a protection device, a switchgear, a compressor, a network switch (e.g., an Ethernet switches), a scanner, a gauge, a valve, a flow meter, and so forth. A user, such as an operator, a technician, a client, or other suitable user, may perform tasks associated with the industrial components. However, it may be difficult for the user to track or recall information regarding each of the industrial components. As a result, it may be difficult for the user to complete certain tasks for the industrial system.

With this in mind, it may be beneficial to use a system that automatically identifies the industrial components and presents information associated with the industrial components to the user. Such information may help the user with completing certain tasks. For example, a computing system may receive image data associated with the industrial component to determine certain properties of the image data. Using the image data, the computing system may query a database that includes information regarding a number of industrial components. The computing system may first filter out irrelevant or unrelated industrial components based on an initial set of properties (e.g., form factor, shape) from the database to efficiently identify the industrial component depicted in the image data. The computing system may also acquire additional information regarding the industrial component by prompting the user for input that includes the additional information to further narrow the search results for the industrial component of the image data. The computing system may then present information associated with the narrowed list of industrial components to the user to assist the user with completing the task associated with the industrial component.

In one implementation, the computing system may assist the user with identifying industrial equipment assemblies or electrical enclosure systems, such as motor control centers (MCCs). Indeed, the computing system may identify a particular electrical enclosure system and/or identification of components associated with the electrical enclosure system based on acquired image data representative of the electrical enclosure system. As an example, the computing system may receive image data of various configurations (e.g., an open configuration, a closed configuration) of the electrical enclosure system to filter out irrelevant or unrelated electrical enclosure systems from search results or other electrical enclosure systems stored in a database. The computing system may also receive additional information (e.g., of certain components associated with the electrical enclosure system) to identify the electrical enclosure system associated with the image data. The computing system may then display a visualization associated with the electrical enclosure system, such as a visualization regarding the components associated with the electrical enclosure system, a visualization regarding related or alternate components that may be used in the electrical enclosure system, or another suitable visualization. The visualization may enable the user with completing tasks associated with the electrical enclosure system. Indeed, the visualization may include documentations or manuals, a schematic diagram of the connection of components, a specification or operating parameter of a component of the electrical enclosure system, a specification or operating parameter of a similar or replacement component of the electrical enclosure system, historical information, tagged information, other suitable visualizations, or any combination thereof. Although the present disclosure primarily discusses usage of the system with respect to industrial system having multiple industrial components, it should be noted that the system may be applied to any other suitable setting in order to identify a component or a group of components of the system.

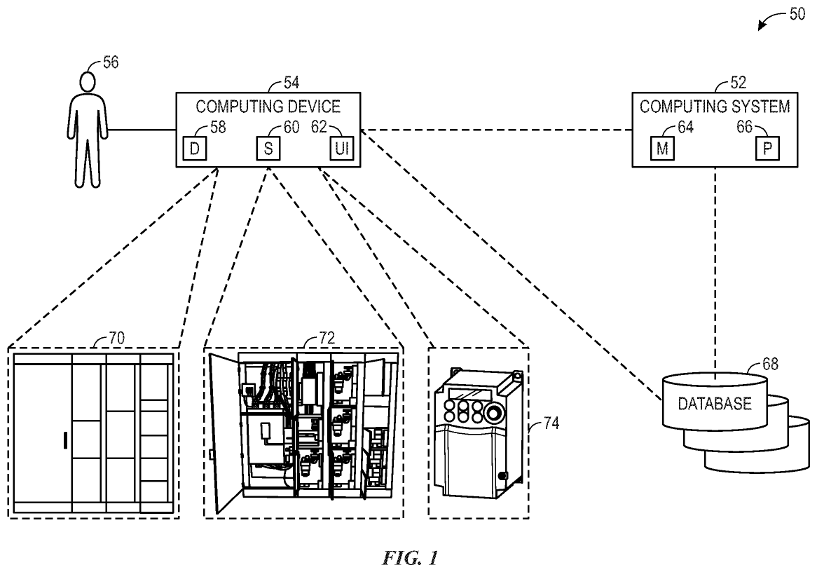

With this in mind, FIG. 1 is a schematic diagram of an embodiment of an image processing system 50 that may be used for identifying information based on image data. The image processing system 50 may include a computing system 52, such as an electronic controller, a mobile computing device, a computing device, and/or a cloud-processing system. The computing system 52 may be communicatively coupled to an computing device 54 of a user 56, such as via any wired or wireless network that may be implemented as a local area network (LAN), a wide area network (WAN), cellular network, radio network, and the like. In additional embodiments, the computing system 52 and the computing device 54 may be a part of a single system or device, instead of being separate entities. In certain implementations, the computing device 54 may include a headset (e.g., a virtual reality headset, an augmented reality headset), a mobile phone, a tablet, a camera, a laptop computer, or any other suitable computing device 54. The computing device 54 may include a display 58 that may present image data (e.g., a visualization) to the user 56. The image data may include an image captured by the computing device 54 and/or other suitable information (e.g., operating data) that may be presented (e.g., overlaid on the image) to the user 56. Such visual data may be collected by a sensor 60 of the computing device 54. The sensor 60, for instance, may include a visual sensor (e.g., a camera) configured to capture images of an environment of the computing device 54, such as images of an industrial component of an industrial system. The sensor 60 may additionally include an audio sensor (e.g., a microphone) configured to collect audio data (e.g., sound), a motion sensor (e.g., an accelerometer, a gyroscope, an inertial measurement unit) configured to detect movement of the computing device 54 and/or of an object (e.g., the user 56) depicted in the image data acquired by the computing device 54, a location sensor (e.g., a global positioning sensor) that may determine a geographic position of the computing device 54, a haptic sensor (e.g., a capacitive sensor) that may detect vibrational or movement data, a temperature sensor that may determine a temperature of the surroundings of the computing device 54, a depth sensor (e.g., a contact sensor, a proximity non-contact sensor) that may determine a distance of objects around the computing device 54, or any other suitable sensor that may determine relevant data. In any case, the computing device 54 may present data collected by the sensor 60 to the user 56 via the display 58.

The computing device 54 may also include a user interface 62, such as a touchscreen (e.g., as a part of the display 58), a button, a knob, a switch, a dial, a trackpad, a mouse, an eye-tracking interface, a gesture or motion controlled interface, a physical (e.g., joystick) controller, or any another suitable feature. The user may utilize the user interface 62 to operate the computing device 54, such as to transmit a user input that instructs the computing device 54 to capture image data (e.g., via the sensor 60). In some embodiments, the computing system 52 may be communicatively coupled to the sensor 60, such that the sensor 60 may transmit the image data to the computing system 52. The computing system 52 may subsequently process the image data. To this end, the computing system 52 may include a memory 64 and processing circuitry 66. The memory 64 may include volatile memory, such as random-access memory (RAM), and/or non-volatile memory, such as read-only memory (ROM), optical drives, hard disc drives, solid-state drives, or any other non-transitory computer-readable medium that includes instructions executable by the processing circuitry 66. The processing circuitry 66 may include one or more application specific integrated circuits (ASICs), one or more field programmable gate arrays (FPGAs), one or more general purpose processors, or any combination thereof, configured to execute the instructions stored in the memory 64 to process image data received from the computing device 54.

Further, the computing system 52 may include and/or be communicatively coupled with a database 68, such as a physical server and/or cloud storage. The database 68 may store data, including information associated with various industrial components. The computing system 52 may, for example, access the database 68 to retrieve information stored in the database 68, and the computing system 52 may transmit the retrieved information to the computing device 54. The computing device 54 may then present the information received from the computing system 52 (e.g., as data visualization to the user 56).

The user 56 may utilize the computing device 54 to collect data in related to industrial equipment in an industrial system. As an example, the user 56 may collect data associated with an industrial equipment assembly in a closed configuration 70. As used herein, the closed configuration 70 of the industrial equipment assembly refers to a configuration that substantially encloses or covers the internal components of the industrial equipment assembly. By way of example, doors, panels, cabinets, drawers, and so forth, may substantially block exposure of the internal components of the industrial equipment assembly may be used to seal off or protect internal components of the industrial equipment assembly from an ambient environment. In the closed configuration 70, the computing device 54 may collect data (e.g., image data) associated with an enclosure of the industrial equipment assembly. For instance, such data may include dimensions (e.g., sizes, geometric shapes) of external components (e.g., sections of the enclosure, latches, knobs, handles) of various sections of the industrial equipment assembly, a layout of the external components of the industrial equipment assembly (e.g., the positioning of the sections relative to one another), a color of the external components of the industrial equipment assembly, other suitable data, or any combination thereof. In addition, the user 56 may collect data (e.g., image data) associated with the industrial equipment assembly in an open configuration 72. As used herein, the open configuration 72 of the industrial equipment assembly refers to a configuration that does not substantially enclose or cover the internal components of the industrial equipment assembly. In other words, the open configuration 72 may correspond to open doors or cabinets. Accordingly, the internal components may be visible (e.g., exposed to the ambient environment) in the open configuration 72, such that users may access to the internal components. The data associated with the industrial equipment assembly in the open configuration 72 may include dimensions (e.g., sizes, geometric shapes) of internal components (e.g., electrical components, interior spaces of the enclosure) of the industrial equipment assembly, a layout (e.g., a wiring schematic) of the interior components of the industrial equipment assembly, a color of the interior, other suitable data, or any combination thereof.

Further, the user 56 may collect data associated with a particular industrial component 74 of the industrial equipment assembly, such as one of the exterior components (e.g., a section of the enclosure) and/or one of the interior components (e.g., a bus bar, a motor, a motor starter, a fuse, a circuit breaker, a motor drive). Such data may include dimensions of the industrial component 74, a color of the industrial component 74, a label (e.g., a manufacturer's logo) of the industrial component 74, a position of the industrial component 74 within the industrial equipment assembly, other features associated with the industrial component 74, or any combination thereof. Although the following disclosure regarding the industrial equipment assembly will primarily be discussed with reference to a motor control center (MCC), it should be noted that the embodiments described below may be implemented or used for any suitable industrial equipment assembly.

The computing system 52 may use the data received from the computing device 54 to identify the particular object captured by the computing device 54. For instance, the database 68 may store information associated with different objects (e.g., different MCCs, different industrial components 74), and the computing system 52 may match features of captured image data with the stored information to identify a relevant object associated with the image data. In other words, the computing system 52 may determine stored information associated with an object that substantially matches features of another object depicted in image data to identify the object. In an example, the computing system 52 may identify certain features of image data associated with an MCC (e.g., in the closed configuration 70 and/or in the open configuration 72), and the computing system 52 may match the features of the image data to information regarding a particular MCC stored in the database 68, thereby associating the particular MCC with the image data. In another example, the computing system 52 may identify certain features of the image data associated with the industrial component 74 (e.g., a motor drive), and the computing system 52 may match the features of the image data to information regarding a particular industrial component (e.g., a specific motor drive model) stored in the database 68 to associate the particular industrial component with the image data.

The computing system 52 may also instruct the computing device 54 to output information to the user 56, such as in response to identifying the object associated with the image data. As an example, in response to identifying the particular industrial component 74, the computing system 52 may instruct the computing device 54 to present information (e.g., a visualization) associated with the industrial component 74 (e.g., manufacturing specifications, documentation, operating information, information associated with related or alternative components for possible replacement). As a result, the user 56 may acquire information associated with the industrial component 74 without having to adjust, suspend, or otherwise impact the operation of the industrial component 74. As another example, in response to identifying a particular MCC associated with the image data, and the computing system 52 may instruct the computing device 54 to present information (e.g., a visualization) associated with the MCC (e.g., a map or layout of the internal components and/or of external components, a bill of materials, operating information regarding the internal components, operating information the overall MCC, documentation). Thus, the user 56 may acquire information regarding the MCC without having to impact the operation of the MCC (e.g., by moving the internal components of the MCC).

In some embodiments, the presented information may include tagged information that is manually (e.g., from the user 56 or from another user) and/or automatically (e.g., via operational data) added and/or modified for a specific industrial component. That is, the tagged information may be used to differentiate an industrial component from similar industrial components (e.g., a similar model of the industrial component). By way of example, the tagged information may include attributes (e.g., a positioning, a component type, an electrical property, a communication property, an environmental or location property, a material composition), notes (e.g., maintenance information, installation information), comments (e.g., information regarding historical usage or installation), or other information that may not be initially identifiable via image data. Accordingly, the tagged information may be more specific to the particular industrial component or MCC (e.g., having a specific catalog number). In some cases, the tagged information may enable the computing system 52 to identify a specific industrial component more accurately. That is, the computing system 52 may store tagged information specific to each industrial component in the database 68, such as during installation, maintenance, and/or modification of the industrial component. The computing system 52 may then match information acquired or determined via image data with the tagged information to identify a particular industrial component associated with the image data. For example, the computing system 52 may further analyze the image data, prompt the user for additional information regarding the image data, or otherwise receive information in addition to the image data for comparison with tagged information. Since the tagged information may be specific to a certain industrial component, the computing system 52 may identify the industrial component associated with the image data more easily based on a match between the tagged information and the information associated with the image data.

The receipt of certain information in addition to image data may further assist the computing system 52 with identifying an industrial component or an MCC more accurately. For instance, the computing system 52 may use such information to identify an object when there is limited information available in the respective image data, such as an image data having a component (e.g., wiring, debris, an enclosure, another device) obstructing a view of the industrial component. In addition, the information may allow the computing system 52 to better identify the industrial component from other industrial components (e.g., a contactor having a first type of contacts may be nearly identical to a contactor having a second type of contacts) that may be substantially similar to the industrial component depicted in the image data. Further, the receipt of additional data may enable the computing system 52 to identify an object without having to store an excessive amount of information in the database 68 or having to process an excess amount of properties of image data, thereby reducing an operating or computing cost associated with operating the image processing system 50 (e.g., the computing system 52).

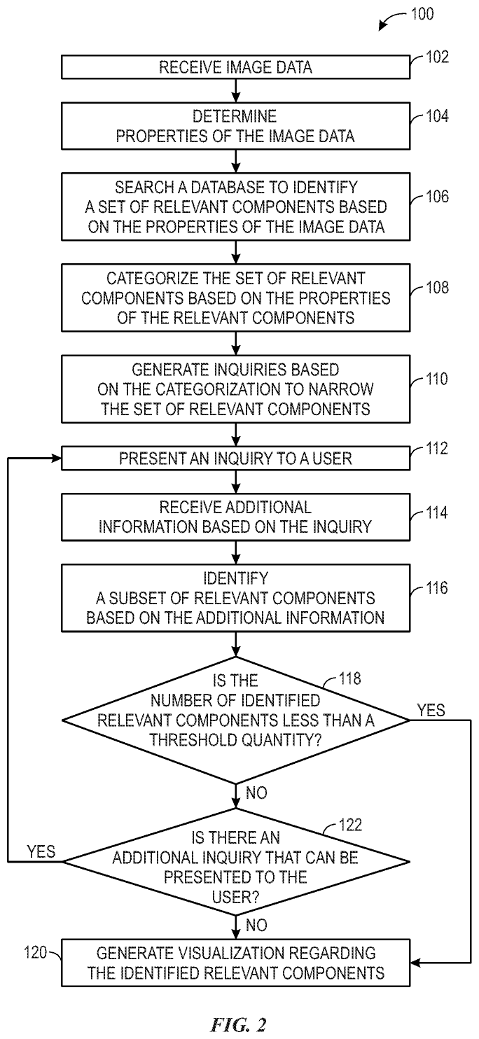

FIGS. 2-4 each illustrate a method or process for identifying information to be presented based on image data associated with an industrial system. As an example, each method may be performed by a control system, such as the computing system 52. It should be noted that each method may be performed differently than depicted in FIGS. 2-4. For instance, additional steps may be performed with respect to the methods, and/or certain steps of the depicted methods may be removed, modified, and/or performed in a different order. It should also be noted that the methods may be performed in a different setting (e.g., a non-industrial system) and/or based on data other than image data.

As mentioned above, it may be difficult for a system to identify an industrial component by using only image data. As an example, the system may not be able to accurately distinguish the industrial component from other industrial components based on only image data. As another example, an excessive amount of computing power and/or cost may be required to store enough information (e.g., on the database 68) regarding various image data to enable the system to accurately identify different industrial components.

Accordingly, FIG. 2 is a flowchart of an embodiment of a method or process 100 for outputting visualizations regarding industrial components based on image data and additional information. At block 102, the computing system 52 may receive image data acquired via the sensor 60 of the computing device 54 or via any other suitable device. In some embodiments, the computing device 54 may capture the image data in response to a user input (e.g., via the user interface of the computing device 54). In additional embodiments, the image data may be automatically received, such as in real-time as the computing device 54 operates in an industrial setting.

At block 104, the computing system 52 may determine properties of the image data. Such properties may be determined, for example, via image recognition techniques (e.g., to determine a color of pixels of the image data, a layout of pixels of the image data), via optical character recognition techniques (e.g., to identify text, analyze semantics), scanning techniques (e.g., identify a quick response code, a barcode), or any combination thereof. Determination of the properties of the image data may enable determination of features of an object associated with the image data. By way of example, based on the properties of the image, different properties of the object, such as a size or dimension of parts of the object (e.g., of wiring of the object), the computing system 52 may identify a color of parts of the object, a surrounding of the object, and so forth.

At block 106, the computing system 52 may search the database 68 to identify possible relevant industrial components associated with the image data based on the determined properties of the image data. That is, the computing system 52 may determine that certain industrial components are not associated with the properties identified at block 104 and may therefore filter out such industrial components as irrelevant or unrelated. For example, by determining a size or dimension of the object associated with the image data, the computing system 52 may identify industrial components that do not have a corresponding size or dimension (e.g., based on information stored in the database 68) as irrelevant. That is, by determining the object (e.g., a drive) has a particular geometry (e.g., a substantially rectangular geometry) and/or a particular size (e.g., dimensions), the computing system 52 may identify industrial components that do not have a substantially the same geometry (e.g., a drive having a circular geometry) and/or substantially the same size (e.g., a drive having a size greater than a threshold dimension or less than another threshold dimension) as irrelevant. As a result, the computing system 52 may identify a set of industrial components that is not filtered out and/or that has the properties identified at block 104 as relevant so as to establish a set of relevant industrial components.

At block 108, the computing system 52 may categorize the set of relevant industrial components based on similar properties of the relevant industrial components. Such properties may include a type of device or machine (e.g., a drive or a motor contactor), an operation parameter (a voltage, a current), a configuration (e.g., a normally closed contactor, a normally open contactor), a manufacturer or vendor (e.g., based on a company logo), additional size or dimension information (e.g., a wire gauge), other suitable properties, or any combination thereof. Thus, the computing system 52 may organize the set of relevant industrial components to differentiate the relevant industrial components from one another.

At block 110, the computing system 52 may generate inquiries or questions based on the categorization to narrow the set of relevant industrial components. The answers or responses to the inquiries may enable the computing system 52 to acquire additional information regarding the object to further identify industrial components that are not relevant, thereby removing such industrial components from the set of relevant industrial components. Such additional information may not have been readily identifiable via the received image data. By way of example, the additional information may include properties with which the set of relevant industrial components are categorized in order to differentiate the object from other industrial components of the set of relevant industrial components. The inquiries may be visually and/or audibly presented to the user and therefore, the inquiries may be worded or otherwise formatted to guide the user with providing the desirable additional information. In some embodiments, the inquiries may be prioritized or ranked based on relevancy, such as how a response to each inquiry may filter out irrelevant industrial components. For instance, an inquiry for prompting the user to provide an operating parameter (e.g., input voltage) of the component may be prioritized over another inquiry for prompting the user to provide a color of the component.

At block 112, the computing system 52 may send one of the generated inquiries to the computing device 54 for view by the user. As an example, the computing device 54 may be instructed to present the inquiry visually (e.g., via the display 58) and/or audibly. In some embodiments, the computing system 52 may send a modified version of the image data (e.g., the original image data received with respect to block 102) captured by the computing device 54 and includes a reference to the inquiry. For instance, the computing system 52 may display an inquiry at a location or position within the image data that corresponds to a feature of the represented component or machine that is related the inquiry. For example, the computing system 52 may position the inquiry in a location relative to the represented component or machine corresponding to an expected location for determining details regarding the requested feature of the inquiry. By way of example, the computing system 52 may present an inquiry associated with an operating parameter adjacent to a manufacturer label and/or an input device identified in the image data to enable the user to determine a response to an inquiry requesting manufacturer information more easily. In additional embodiments, the computing system 52 may present the inquiry along with a suggested answer or response (e.g., based on information received via the sensor 60). For instance, the inquiry may include prompting the user to identify an operating parameter of a motor, and the computing system 52 may suggest answers based on a size of the motor identified via the received image data.

At block 114, the computing system 52 may receive the additional information from a user input received via the computing device 54 or the like. In an example, the user input may include a visual input (e.g., via a text input, a gesture, a selection from a drop-down menu listing icons of possible selections). In another example, the user input may be received via an audio input (e.g., via spoken words). In yet another example, the user input may be image or video data representative of the answer to the inquiry. In any case, in response to receipt of additional information, the computing system 52 may identify a subset of relevant industrial components from the set of relevant industrial components, as indicated at block 116. That is, the computing system 52 may narrow the set of relevant industrial components by identifying certain industrial components from the set of relevant industrial components as unassociated with or unrelated to the additional information (e.g., the industrial components do not include properties associated with the additional information) and may therefore as irrelevant. As a result, the remaining industrial components of the set of relevant industrial components may still be considered as relevant to establish the subset of relevant industrial components.

In additional embodiments, the computing system 52 may identify additional information automatically (e.g., without a user input). As an example, the additional information may be acquired from other sensors of the computing device 54. For instance, sensor data that includes a location, an audio output (e.g., generated noise during operation), a temperature, a movement, or another parameter related to the object associated the image data may be received by the computing system 52. In further embodiments, the computing system 52 may determine the additional information indirectly based on certain previously received information. By way of example, receiving additional information associated with a first operating parameter (e.g., a rated voltage) may enable identification of further information associated with a second operating parameter (e.g., a rated power level). In additional embodiments, the additional information may be based on information retrieved in the database 68 and referred to based on the image data. For instance, based on identified features associated with the image data, the computing system 52 may search for certain data (e.g., a schematic diagram) stored in the database 68 to identify additional information that may be used to filter the set of relevant industrial components. In further embodiments, the computing system 52 may communicate with industrial components to receive additional information. For example, the computing system 52 may determine that communications are established with a portion of the industrial components of the set of relevant industrial components. Thus, the computing system 52 may send a communication signal to such industrial components to request for additional information (e.g., current operation information) for filtering the set of relevant industrial components.

The additional information may also assist the computing system 52 to associate future image data acquisitions to the subset of relevant industrial components based on similarities between the previously analyzed image data and recently acquired image data. That is, after receiving image data that is similar to other image data previously analyzed as described above, the computing system 52 may directly associate the similar image data with the subset of relevant industrial components without initially associating the similar image data with the initial set of relevant industrial components (e.g., identified with respect to block 106). As such, receiving similar image data at a later time may enable the subset of relevant industrial components to be established without having to present the same inquiry to the user, thereby improving the identification of relevant industrial components.

At block 118, the computing system 52 may determine whether the number of identified industrial components is less than a threshold quantity. The threshold quantity may enable a suitable amount of information regarding the identified industrial components to be presented to the user. For instance, the threshold quantity may include a limited number of industrial components to avoid overloading or overwhelming the user with excessive information (e.g., associated with an excessive number of industrial components). For example, the threshold quantity may be two industrial components, three industrial components, five industrial components, or any suitable number of industrial components that may allow a user to visually view information regarding each component via the display 58. As such, the threshold quantity may depend on the type of display 58 being used to view the components.

If a determination is made that the number of identified relevant industrial components is below the threshold quantity, the computing system 52 may present a visualization regarding the identified relevant industrial components to the user (e.g., via the display 58 of the computing device 54), as shown at block 120. The visualization may include information regarding the identified relevant industrial components. In some embodiments, such information may be stored in the database 68. For example, the information may include manufacturer information, tagged information, documentation, other image data, and so forth. In additional embodiments, information may be searched or retrieved from other sources, such as from the Internet. As an example, the information (e.g., operational information, cost information) may be associated with similar, alternative, or replacement industrial components. In this manner, the user may compare other industrial components with the identified industrial components in order to determine whether it may be beneficial to replace currently installed components and/or to improve the design of the currently installed components. In further embodiments, the computing system 52 may present real-time information associated with the identified relevant industrial components. For instance, the computing system 52 may transmit communication signals to the identified relevant industrial components to request or query real-time information (e.g., a current or historical operating status) from the identified relevant industrial components. In response to receiving the communication signals, the industrial components may send the real-time information (e.g., via sensor data) to the computing system 52, which may then present the real-time information to the user.

Although the present disclosure primarily discusses generating a visualization based on a number of identified industrial components relative to a threshold quantity, in additional embodiments, visualizations may be generated based on another comparison. For instance, visualizations may be generated based on a respective confidence level of each relevant industrial component being above a threshold confidence level. That is, the confidence level may indicate an extent in which the properties of the image data match with an identified industrial component so as to indicate a probability in which the industrial component associated with the image data is accurately identified. As such, the visualizations may be generated when the computing system 52 has determined the industrial component is likely identified within the set or subset of identified relevant components. For example, there may be 10 relevant industrial components identified, but only one of the industrial components may have an associated confidence level above 90 percent. Thus, a visualization regarding the one industrial component and not the other nine industrial components may be generated and presented.

In any case, the computing system 52 may present the visualization to the user by modifying the image data (e.g., the original image data received with respect to block 102) presented to the user. In certain embodiments, the computing system 52 may present the visualization in a manner that avoids obscuring the object associated with the image data. That is, for example, the computing system 52 may determine a location or position of the object within the image data, and the computing system 52 may present the visualization such that the location or position of the visualization does not overlap with the location or position of the object (e.g., the visualization is presented to the side of the object). As a result, the computing system 52 may present the visualization in a manner that does not affect the user's ability to view the object or perform their task.

However, if a determination is made that the number of identified industrial components is not below the threshold quantity, the computing system 52 may make a further determination regarding whether there is an additional inquiry (e.g., from the inquiries generated with respect to block 110) that is available to be presented to the user, as indicated at block 122. In other words, the computing system 52 determines whether further information may be acquired to differentiate the object from other identified relevant industrial components in order to further narrow the set of relevant industrial components. If the computing system 52 determines that there is an additional inquiry available for presentation to the user, the steps with respect to blocks 112-118 may be performed again to present the inquiry to the user, to receive additional information via the presented inquiry, to narrow the subset of relevant industrial components (e.g., by removing irrelevant industrial components from the subset of relevant industrial components), and to determine whether the number of narrowed subset of relevant industrial components is below the threshold quantity. In this way, the additional inquiry may be used to reduce the number of identified relevant industrial components. Indeed, the computing system 52 may present any suitable number of additional inquiries to the user to reduce the number of identified relevant industrial components, such that a suitable amount of information is presented to the user based on the display 58. In certain embodiments, the computing system 52 may organize the inquiries to determine an order in which the inquiries are to be presented to the user, such as based on relevancy or priority. For example, information regarding a wire size may be more useful than information regarding a color of wires for narrowing the number of relevant industrial components. In addition, the computing system 52 may organize and present the inquiries based on the categorization of the set of relevant industrial components in order to reduce the number of relevant industrial components more effectively.

In embodiments in which visualizations are generated based on a respective confidence level associated with each industrial component, the computing system 52 may determine whether further information is to be acquired to increase a respective confidence level of the identified relevant industrial components. For instance, if a confidence level of one of the relevant industrial components is slightly below the threshold confidence level, the computing system 52 may identify an inquiry to be presented in order to increase the confidence level of the relevant industrial component above the threshold confidence level. Indeed, the presented inquiry may have a suggested answer or response, and if the computing system 52 receives an indication that the user verifies the suggested answer or response, the computing system 52 may increase the confidence level associated with one of the relevant industrial components. In any case, the computing system 52 may present the inquiries so as to determine visualizations may be generated for the remaining subset of relevant industrial components.

If the computing system 52 determines that there is no additional inquiry that may be presented to the user, the computing system 52 may present the visualization for the current set of relevant industrial components without further narrowing the current set of relevant industrial components, as indicated at block 120. In such circumstances, the number of relevant industrial components may be greater than the threshold quantity, such that the visualization may include an amount of information that is greater than a suitable or desirable amount of information. For this reason, the computing system 52 may present the visualization in a manner that does not overload or overwhelm the user. As an example, the computing system 52 may selectively present respective visualizations associated with the relevant industrial components, such as visualizations having a respective confidence level that is above a threshold confidence levels. That is, the user may select a particular visualization to be presented (e.g., from a list of selectable icons associated with possible visualizations), and a remainder of the visualizations may not be presented (e.g., the remainder of visualizations may remain hidden). In this example, the computing system 52 may present a notification to the user to indicate that an excessive number of visualizations are available and may be readily presented, and the computing system 52 may present a menu or list of the visualizations (e.g., selectable icons) to the user to enable the user to select a particular visualization from the menu. For instance, the user may utilize the menu to select a particular visualization for presentation via a visual input, an audio input, a gesture, or any combination thereof, such as based on identifying that the industrial components associated with the particular visualization accurately reflects the image data. Such selection may then be used by the computing system 52 as training data to enable identification of further image data, such as by determining that certain properties of the image data are associated with the industrial components of the particular visualization selected by the user.

In some circumstances, a user may be performing a task on an MCC. The MCC may include multiple components that may present a challenge for the user to identify the MCC for performing the task. For example, it may be difficult for the user to acquire information regarding each of the components enclosed within the MCC. Indeed, an industrial system may include multiple MCCs that each includes a unique set of components, and the user may not be able to distinguish the MCCs based on the components included within the MCCs.

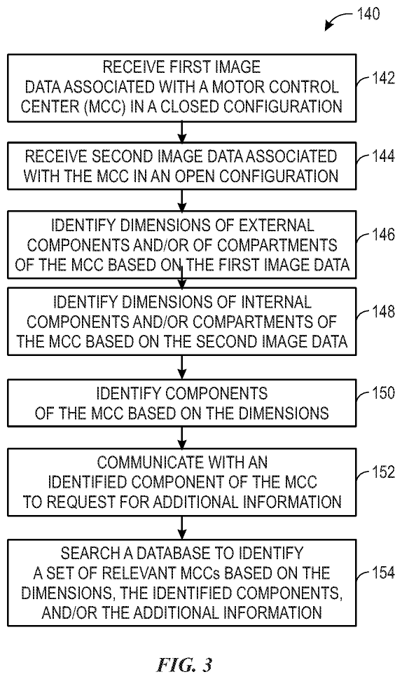

With this in mind, FIG. 3 is a flowchart of an embodiment of a method or process 140 for identifying relevant MCCs based on image data. That is, the method 140 may narrow the number of possible MCCs that are relevant to the user for helping the user identify a particular MCC and therefore perform a task on the particular MCC. In some embodiments, multiple image data may be used to identify the relevant MCCs. For example, at block 142, the computing system 52 receives first image data associated with (e.g., representative of) an MCC in a closed configuration 70, such as via the computing device 54. In the closed configuration 70, the internal components of the MCC may not be visible (e.g., the enclosure of the MCC substantially covers the internal components). As such, the image data of the MCC in the closed configuration 70 may primarily include different aspects of the enclosure of the MCC as compared to image data of the MCC in the open configuration 72. That is, the internal components of the MCC may not be viewable in the closed configuration 70. Further, at block 144, second image data associated with the same MCC in an open configuration 72 may be received via the computing device 54. In the open configuration 72, the internal components of the MCC may be visible (e.g., the enclosure of the MCC does not substantially cover the internal components). Thus, the image data of the MCC in the open configuration 72 may include aspects of both the enclosure (e.g., the internal spaces of the enclosure) and also of the internal components.

At block 146, the computing system 52 identifies dimensions of external components and/or compartments of the MCC based on the first image data. The external components may include various parts of the enclosure of the MCC, such as panels, doors, frames, latches, knobs, logos, and the like. Thus, the dimensions of the external components may be used to identify certain mechanisms or features of the enclosure. The compartments may include various sections in which the enclosure is divided and therefore, the dimensions of the compartments may be used to identify a layout of the enclosure and/or a size of different parts of the enclosure. Furthermore, the dimensions of the external components may be associated with the dimensions of the compartments. For instance, a first position of an external component having a first dimension may be determined to be associated with (e.g., overlapping) a second position of a compartment having a second dimension.

At block 148, the computing system 52 identifies dimensions of internal components and/or of compartments of the MCC based on the second image data. The internal components may include electrical components, such as a bus bar, a drive, wiring, and so forth. Further, the compartments identified based on the second image data may include a size of the internal volumes associated with each compartment. Information related to the internal components may also be compared with information related to the compartments. For example, a first position of an internal component having a first dimension may be determined to be associated with (e.g., overlapping) a second position of a compartment having a second dimension.

In certain embodiments, the computing system 52 may identify information in addition to dimensions based on the first image data and/or the second image data. For example, other visual properties (e.g., a color, an orientation) of certain components may be determined based on the image data. In additional embodiments, the computing system 52 may determine certain properties of the MCC based on the dimensions. As an example, the computing system 52 may determine a voltage, a current, and/or a power level (e.g., an input voltage, an input current, an input power) associated with the MCC based on a size of a bus bar and/or wiring in the second image data. Thus, the computing system 52 may derive additional information based on the dimensions.

At block 150, the computing system 52 may identify components of the MCC based on the dimensions identified with respect to blocks 146 and 148. By way of example, the computing system 52 may determine that the dimensions associated with image data match with corresponding dimensions of a certain type of component (e.g., a contactor). In this way, the types of components may be determined and associated with the MCC (e.g., with the compartments of the MCC). For instance, the computing system 52 may determine that a first type of component (e.g., a drive) is positioned within a first compartment, and a second type of compartment (e.g., wiring) is positioned within a second of compartment. Thus, the layout of various components with respect to the compartments may be determined to enable identification of the MCC and/or of the component itself (e.g., the type or model of the component). In additional embodiments, the computing system 52 may determine specific components of the MCC. For example, based on the dimensions, a particular internal component (e.g., a motor having a specific catalog or model number) of the MCC may be identified and associated with a compartment of the MCC. Identification of a specific component may further facilitate identification of the MCC, as described with respect to block 152.

At block 152, the computing system 52 may communicate with an identified industrial component of the MCC to request for additional information from the identified industrial component. That is, in response to identification of a specific industrial component, the computing system 52 may determine that communication with the specific industrial component (e.g., a sensor of the specific industrial component) is established. As such, the computing system 52 may transmit a communication or control signal to the specific industrial component to request for the additional information. In response to the receipt of the communication signal, the specific industrial component may transmit the additional information. Such additional information may include real-time information (e.g., current operating information), historical information (e.g., previous operating information), additional specifications (e.g., documentation), other suitable information, or any combination thereof.

At block 154, the computing system 52 may search the database 68 to identify a set of relevant MCCs based on the dimensions of image data (e.g., identified with respect to blocks 146 and 148), the components of the MCC (e.g., identified with respect to block 150), and/or additional information (e.g., received with respect to block 152). In an example, information associated with different MCCs (e.g., information regarding various components included in the MCCs) is stored in the database 68. Thus, the computing system 52 may compare the information acquired or derived based on the first and second image data with the information stored in the database 68 to identify possible MCCs associated with the first and second image data (e.g., MCCs having properties associated with the information acquired from the first and second image data). For example, based on the identified components of the MCC (e.g., a quantity of a certain type of components, a position of components relative to one another), the computing system 52 may identify MCCs that do not have the identified components (e.g., substantially the same quantity of the type of components, substantially the same position of components relative to one another) as irrelevant and may filter out such MCCs. Thus, the computing system 52 may identify a remainder of the MCCs as relevant to establish the set of relevant MCCs.

Relevant MCCs may also be identified by receiving other information in addition to image data. For example, the set of relevant MCCs identified with respect to block 154 may be further narrowed based on other information. As such, the other information may be used to further help the user distinguish MCCs from one another and perform a task on one of the MCCs.

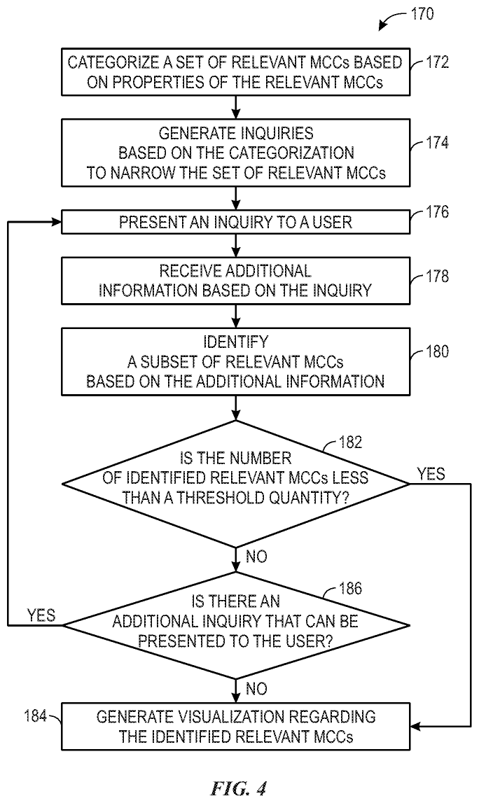

FIG. 4 is a flowchart of an embodiment of a method or process 170 for outputting visualizations regarding relevant MCCs based on received information. At block 172, the computing system 52 may categorize a set of relevant MCCs (e.g., established via block 154 of FIG. 3) based on properties of the relevant MCCs. That is, the computing system 52 may organize the relevant MCCs based on properties that may differentiate the MCCs from one another, such as a number of different types of components, a particular model of components (e.g., of the internal components), an operating status of the MCCs (e.g., a current operating mode of an internal component), other suitable properties, or any combination thereof.

At block 174, the computing system 52 may generate the inquiries based on the categorization of MCCs to narrow the set of relevant MCCs. In particular, the inquiries facilitate acquiring additional information to filter out MCCs from the set of relevant MCCs. The additional information may not have been readily available via a received image data and may, for instance, include specific information that facilitates identification of the external and/or internal components and/or information regarding an aspect of the overall MCC (e.g., a physical location of the MCC).

At block 176, the computing system 52 may present one of the generated inquiries to the user to guide the user with providing the desirable additional information. For example, the computing system 52 may visually present an inquiry regarding a particular component of the MCC at a location proximate the particular component of the MCC via the display 58 of the computing device 54. In additional embodiments, the computing system 52 may audibly present the inquiry to the user. In further embodiments, the inquiry may include suggested or possible responses (e.g., via a menu or list) from which the user may select, such as based on properties of the image data, and further guiding the user to provide the additional information. For instance, based on the dimensions of the MCC identified via the first image and/or the second image, the computing system 52 may identify possible operating parameters of the MCC and may present an inquiry suggesting the possible operating parameters for confirmation by the user.

In any case, the computing system 52 may receive additional information based on the inquiry, as shown at block 178. The computing system 52 may receive additional information via user input, such as via visual input and/or audio input received by the computing device 54. In response to receipt of the additional information, the computing system 52 may identify a subset of relevant MCCs, as indicated at block 180. As an example, the computing system 52 may filter out MCCs that are not associated with or not related to the additional information from the set of relevant MCCs. Thus, the computing system 52 reduces the number of relevant MCCs to establish the subset of relevant MCCs.

In additional embodiments, as described above, the computing system 52 may identify additional information automatically, such as without presenting the inquiry to the user and/or without receiving a user input. In an example, the computing system 52 may transmit communication signals (e.g., in addition to the communications signals transmitted at block 152 of FIG. 3) to an identified industrial component to request for additional information from the identified industrial component. In another example, the computing system 52 may automatically receive the additional information (e.g., a location or position of the MCC) from the computing device 54 (e.g., a sensor of the computing device 54). In any case, the computing system 52 may acquire the additional information to reduce the number of identified relevant MCCs.

At block 182, the computing system 52 may determine whether the number of identified relevant MCCs is less than a threshold quantity, which enables a suitable amount of information regarding the relevant MCCs to be presented to the user. That is, the threshold quantity may include a limited number of MCCs to avoid overloading or overwhelming the user with information. If the computing system 52 determines that the number of identified relevant MCCs is less than the threshold quantity, a visualization regarding the identified relevant MCCs may be presented to the user (e.g., via the display 58 of the computing device 54), as indicated at block 184. In some embodiments, the visualization may include information regarding the particular components of each identified relevant MCC. For example, such information may be associated with the currently installed components (e.g., manufacturer information, tagged information, documentation, other image data, operational information) and/or of similar (e.g., alternative) components. In additional embodiments, the visualization may include information regarding the overall identified relevant MCCs. By way of example, the visualization may include installation information regarding the MCC, an overall operation of the MCC, a bill of materials of the MCC, and so forth. In any case, the computing system 52 may present the visualization by modifying an image data (e.g., the original first image data received with respect to the block 142 of FIG. 3, the original second image data received with respect to the block 144 of FIG. 3). As an example, the computing system 52 may present information regarding specific components proximate to such components in the image data. Thus, the user may utilize the visualization to obtain desirable information regarding the MCC.

However, if the computing system 52 determines that that the number of identified relevant MCCs is greater than the threshold quantity, the computing system 52 may further determine whether there is an additional inquiry (e.g., from the inquiries generated at block 174) is available for presentation to the user, as indicated at block 186. In this way, the computing system 52 determines whether further information may be acquired to reduce the number of identified relevant MCCs. If the computing system 52 determines that there is an additional inquiry that is available for presentation to the user, the steps with respect to blocks 176-182 may be performed to present the inquiry to the user, to receive additional information via the presented inquiry, to identify an updated subset of relevant MCCs (e.g., by removing irrelevant MCCs from the subset of MCCs) based on the additional information, and to determine whether the number of relevant MCCs in the updated subset of relevant MCCs is below the threshold quantity. Thus, the computing system 52 may present any suitable number of subsequent inquiries to the user to reduce the number of identified MCCs. In certain embodiments, the computing system 52 may organize the inquiries based on the categorization of the relevant MCCs such that inquiries may be presented in an order to reduce the number of relevant MCCs more effectively. For example, the computing system 52 may present a first inquiry that filters out a greater number of relevant MCCs before presenting a second inquiry that filter out a smaller number of relevant MCCs.

If the computing system 52 determines that there is no additional inquiry that may be presented to the user, the visualization regarding the identified relevant MCCs may be presented without further narrowing of the subset of identified relevant MCCs, as shown at block 184. However, since the number of relevant MCCs may be greater than the threshold quantity in this circumstance, the computing system 52 may present the visualization in a manner to avoid overloading or overwhelming the user, such as by ranking visualizations based on confidence level. For instance, the computing system 52 may selectively present the respective visualizations associated with relevant MCCs based on a user input (e.g., via selection from a menu or list of possible visualizations). Thus, the computing system 52 may present a selected visualization, while hiding a remainder of the visualizations. As a result, the computing system 52 may present a limited number or amount of visualizations to enable the user to continue to view image data.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method executable by at least one processor, the method comprising:
receiving image data representative of an industrial equipment assembly;
identifying a plurality of properties associated with the industrial equipment assembly based on the image data;
identifying a set of industrial equipment assemblies associated with the industrial equipment assembly based on the plurality of properties associated with the industrial equipment assembly and data associated with a plurality of industrial equipment assemblies stored in a database;
categorizing the set of industrial equipment assemblies based on the data associated with the plurality of industrial equipment assemblies;
generating an inquiry based on the categorization of the set of industrial equipment assemblies;
presenting the inquiry via an electronic display;
receiving information associated with the industrial equipment assembly, wherein the information is responsive to the inquiry;
identifying a subset of industrial equipment assemblies from the set of industrial equipment assemblies based on the information; and
presenting a visualization associated with the subset of industrial equipment assemblies via the electronic display.

2. The method of claim 1, wherein generating the inquiry based on the categorization of the set of industrial equipment assemblies comprises:
determining whether a number of industrial equipment assemblies in the subset of industrial equipment assemblies is greater than a threshold quantity;
determining whether an additional inquiry is available for presentation in response to determining that the number of industrial equipment assemblies in the subset of industrial equipment assemblies is greater than the threshold quantity; and
presenting the additional inquiry via the electronic display in response to determining that there is an additional inquiry available for presentation.

3. The method of claim 2, comprising:
receiving additional information based on the additional inquiry;
identifying an additional subset of industrial equipment assemblies from the subset of industrial equipment assemblies based on the additional information; and
updating the visualization representative to include the additional subset of industrial equipment assemblies.

4. The method of claim 1, wherein categorizing the set of industrial equipment assemblies is based on a component of the set of industrial equipment assemblies, an operating status of the component of the set of industrial equipment assemblies, or both.

5. The method of claim 1, wherein identifying the subset of industrial equipment assemblies from the set of industrial equipment assemblies comprises removing an additional subset of industrial equipment assemblies from the set of industrial equipment assemblies based on the information, and wherein the additional subset of industrial equipment assemblies is not associated with the additional information.

6. The method of claim 1, wherein the information is received via user input, one or more sensors, or both.

7. The method of claim 1, wherein presenting the inquiry comprises modifying the image data representative of the industrial equipment assembly to display the inquiry based on a feature of the inquiry and a property of the plurality of properties associated with the industrial equipment assembly.

8. A non-transitory computer-readable medium comprising computer-executable instructions that, when executed by processing circuitry, are configured to cause the processing circuitry to perform operations comprising:
receiving first image data representative of a motor control center (MCC) in a closed configuration;
receiving second image data representative of the MCC in an open configuration;
identifying a first plurality of properties associated with the MCC in the closed configuration based on the first image data;
identifying a second plurality of properties associated with the MCC in the open configuration based on second image data;
identifying a set of components of the MCC based on the first plurality of properties, the second plurality of properties, or both;
identifying a set of MCCs that is associated with the MCC based on the first plurality of properties and based on data associated with a plurality of MCCs stored in database, the second plurality of properties, the set of components, or any combination thereof; and
presenting a visualization representative of the set of MCCs via an electronic display.

9. The non-transitory computer-readable medium of claim 8, wherein each MCC of the set of MCCs comprises each component of the set of components.

10. The non-transitory computer-readable medium of claim 8, wherein the first plurality of properties comprises a first set of dimensions associated with an external component positioned on an exterior of the MCC, a second set of dimensions associated with a compartment of the MCC, or both.

11. The non-transitory computer-readable medium of claim 8, wherein the second plurality of properties comprises a first set of dimensions associated with an internal component of the MCC, a second set of dimensions associated with a compartment of the MCC, or both.

12. The non-transitory computer-readable medium of claim 8, wherein the instructions, when executed by the processing circuitry, are configured to cause the processing circuitry to perform the operations comprising:
identifying a component of the set of components;
sending a request for additional information to the component; and
identifying the set of MCCs based on the first plurality of properties, the second plurality of properties, the set of components, and the additional information.

13. The non-transitory computer-readable medium of claim 8, wherein the instructions, when executed by the processing circuitry, are configured to cause the processing circuitry to perform the operations comprising:
identifying a third plurality of properties associated with the set of MCCs based on the data stored in the database;
categorizing the set of MCCs based on the third plurality of properties;
generating an inquiry based on the categorized the set of MCCs; and
display the inquiry via the electronic display.

14. The non-transitory computer-readable medium of claim 13, wherein the instructions, when executed by the processing circuitry, are configured to cause the processing circuitry to perform the operations comprising:
receiving additional information in response to the inquiry;
identifying a subset of the set of MCCs based on the additional information; and
presenting an additional visualization representative of the subset of MCCs via the electronic display.

15. The non-transitory computer-readable medium of claim 8, wherein the visualization comprises information associated with the set of components, information associated with a set of alternative components that corresponds to the set of components, or both.

16. The non-transitory computer-readable medium of claim 8, wherein the instructions, when executed by the processing circuitry, are configured to cause the processing circuitry to the perform the operations comprising:
generating a plurality of visualizations, wherein each visualization of the plurality of visualizations is representative of one MCC of the set of MCCs;
displaying a menu comprising a plurality of selectable icons, wherein each selectable icon of the plurality of selectable icons is associated with a respective visualization of the plurality of visualizations;
receiving a user input indicative of a selection of one of the plurality of selectable icons; and
presenting a first visualization of the plurality of visualizations that corresponds to the selection.

17. A system, comprising:
a database configured to store data associated with a plurality of industrial components; and
a computing system configured to perform operations comprising:
receiving image data representative of a component;
determining a first plurality of properties of the component based on the image data;
identifying a set of industrial components from the plurality of industrial components based on the first plurality of properties of the component and based on the data associated with the plurality of industrial components stored in the database;
categorizing the set of industrial components based on a second plurality of properties associated with the set of industrial components;
generating a set of inquiries based on the categorization of the set of industrial components;
presenting an inquiry of the set of inquiries via an electronic display;
receiving additional information based on the inquiry;
identifying a subset of industrial components from the set of industrial components based on the additional information; and
presenting a visualization representative of at least one industrial component of the subset of industrial components via the electronic display.

18. The system of claim 17, wherein the computing system is configured to perform the operations comprising:
organizing the set of inquiries in an order for presentation based on the categorization of the set of industrial components; and
presenting the inquiry of the set of inquiries based on the order for presentation.

19. The system of claim 18, wherein the computing system is configured to perform the operations comprising:
determining whether a number of industrial components of the subset of industrial components is greater than a threshold quantity;
determining whether there is another inquiry of the set of inquiries available for presentation in response to the number of industrial components of the subset of industrial components being greater than the threshold quantity;
selecting an additional inquiry from the set of inquiries based on the order for presentation; and
presenting the additional inquiry.

20. The system of claim 17, wherein the computing system is configured to perform the operations comprising:
sending a request to an industrial component of the subset of industrial components for real-time information;
receiving the real-time information from the industrial component in response to the request; and
presenting another visualization representative of the real-time information via the electronic display.
